(19) United States
(12) Patent Application Publication
(10) Pub. No.: US 2006/0014298 A1
(43) Pub. Date: Jan. 19, 2006

(54) Method and kitset for sampling and storage of biological samplies

(75) Inventors: Kevin John Shirley, Christchurch (NZ); Michael Lewis Tate, Dunedin (NZ)

Correspondence Address: SUGHRUE MION, PLLC, 2100 PENNSYLVANIA AVENUE, N.W., SUITE 800, WASHINGTON, DC, 20037, US

(73) Assignee: AGRESEARCH LIMITED, LINGARD LABEL COMPANY LIMITED

(21) Appl. No.: 11/232,010

(22) Filed: Sep. 22, 2005

Related U.S. Application Data
(63) Continuation of application No. 09/958,898, filed on Jan. 18, 2002, now abandoned.
Application No. 09/958,898 is a continuation of application No. PCT/NZ00/00050, filed on Apr. 7, 2000.

(30) Foreign Application Priority Data
Apr. 13, 1999 (NZ) 335233

(51) Int. Cl. G01N 1/00

(52) U.S. Cl. 436/174

(57) ABSTRACT

The invention relates to a method and kitset for rapid collecting and storing of a plurality of biological samples for later identification of the individual sources of the samples. The preferred types of samples described are sources of DNA such as blood. The invention is particularly useful in the tracing of meat specimens back to the carcasses from which they originated, but many other applications are possible.

This is a continuation of application Ser. No. 09/958,898 filed Jan. 18, 2002, which is a Continuation Application of PCT Application No. PCT/NZ00/00050 filed Apr. 7, 2000. The entire disclosure(s) of the prior application(s), application Ser. No. 09/958,898 is hereby incorporated by reference.

### TECHNICAL FIELD

This invention relates to a method and a kitset for collecting and storing a plurality of biological samples for later identification of individual samples. It is particularly suited for the collection and storage of sources of DNA, for example of blood. In a particularly preferred embodiment it may be used in a system for tracing meat specimens back to the carcass from which the meat originated.

### BACKGROUND ART

U.S. Pat. No. 5,092,466 describes a very sophisticated storage system for storing very large numbers of samples of protein gene products or hybridoma cells. The samples are collected on a porous medium such as filter paper. The samples are then lyophilised and placed in an air tight packet. This packet is then welded on to motion picture film stock with appropriate identification such as a bar code. The sample can be punched out of the film. The film can be spliced in the same manner as normal movie stock. This is a very convenient system for storing millions of samples in a retrievable compact storage system.

U.S. Pat. No. 5,460,057 describes a method and apparatus particularly adapted for handling blood samples. This also involves the use of filter paper to collect the samples.

The filter paper is attached to an identification label. When the samples are to be analysed a punch is used to punch out a small portion of the sample on the filter paper and it is then analysed.

A suitable filter paper medium for absorbing and storing of DNA samples is described in U.S. Pat. No. 5,496,562. This is a solid matrix impregnated with a compound or composition which protects against degradation of DNA which is incorporated into or absorbed on the matrix. The matrix claimed is a cellulose based matrix. The impregnated DNA stabilising composition consists of a weak base, a chelating agent, an ionic surfactant or detergent and optionally uric acid or a urate salt.

Other DNA storage matrices are described in U.S. Pat. Nos. 5,756,126; 5,807,527; 5,972,360; 5,976,572 and 5,985,327. Similar DNA storage matrices are described in WO 90/03959 and AU 691,114.

EP 0741 296A relates to a pre-transfusion card designed to determine the compatibility of donor and recipient blood.

U.S. Pat. No. 2,734,503 describes a bandage comprising a polymeric elastic backing on which is superimposed an adherent pad dressing, one side of the backing being covered with an adhesive.

FR 2621690A relates to a device intended to act as a support for samples, in particular biological samples.

While systems are known from the prior art described above for the identification storage and retrieval of DNA samples under laboratory conditions. When samples are to be taken from large numbers of animals in a race or pen or moving carcasses on the killing chain of an animal slaughterhouse quick and accurate sample taking is required.

It is an object of this invention to go some way towards achieving this desideratum or at least to offer the public a useful choice.

Although the present invention was conceived in the environment of a killing chain, its use is not limited thereto and can be used in any system where biological samples need to be taken from a plurality of individual sources, stored and then are able to be individually traced back to their original sources.

### SUMMARY OF INVENTION

Accordingly, the invention may be said broadly to consist in a method for collecting and storing a biological sample for later identification of the source of said sample which comprises the steps of:
providing a sampling strip, one face of which has an absorbent area impregnated with a DNA stabilising composition, and an adhesive area; the other face of which covers and protects the sampling area,
providing an identification substrate having a surface area to receive said sampling strip, applying said sampling strip containing said biological sample to said substrate so that said absorbent area is enveloped between the outer face of said strip and said substrate,
marking each said substrate and/or said sampling strip either before, during or after said applying stage with indicia to identify the source of the biological sample collected on said sampling strip, and
storing said combined marked substrate/strip.

Preferably said biological sample is a source of DNA.

Preferably said source of DNA is blood, lymph or saliva.

Preferably said biological sample is taken from an animal carcass.

In one embodiment said identification substrate is a carcass ticket.

Alternatively said DNA sample is taken from a live animal.

In another embodiment said substrate is a document of description.

Preferably said method is used within a system to trace the origin of meat or other food stuffs.

Preferably said marked combined substrate/strip is stored in dry storage.

Preferably said marking is done on said identification substrate before said sampling strip is affixed thereto.

In another embodiment the invention may be said broadly to consist in a biological specimen sample storage and identification kitset comprising:
a sampling strip consisting essentially of:
a backing sheet, one side of which covers and protects the sampling area,
a layer of adhesive covering and adhered to the other face of said backing sheet,
a biological sample absorbent area impregnated with a DNA stabilising composition adhered to adhesive layer on said backing sheet, the area covered by said absorbing sheet being limited to leave a sufficient area of exposed adhesive to allow said backing sheet to be stuck to a substrate with said absorbing sheet therebetween, and
a substrate to which said sampling strip may be affixed by said adhesive, said substrate being capable of receiving printed indicia to identify the source of said sample.

Preferably said biological sample is a source of DNA.

More preferably said sample is blood, lymph or saliva.

Preferably said adhesive is selected for high stickability and to maintain adhesion at cold storage temperatures.

Preferably said adhesive is a food grade adhesive.

Preferably said adsorbing sheet is DNA sampling paper.

Preferably said filter paper is treated to maintain DNA in a stable state.

Preferably said sampling strip is supplied with said adhesive and sampling sheet face down on a sheet of roll stock whose surface has low adhesivity to allow quick removal of said sampling strip.

Preferably there are perforations through said backing sheet along outer periphery of said sampling sheet.

In one embodiment said substrate is a carcass ticket.

In another embodiment said substrate is a document of description.

In an alternative embodiment a first portion of said sampling strip is adhered to or is integral with said substrate and a second portion faces away from said substrate, a release sheet being releasably adhered to said second portion of said sampling strip, said substrate being adapted to receive said second portion and to be adhered thereto when said release sheet has been removed and said second portion is applied thereto.

The invention may also be said to consist in a method as defined above which comprises using said alternative kitset embodiment, removing said release sheet, applying said sample absorbing sheet to said source of DNA and sticking said second portion of said sampling strip to said substrate.

### BRIEF DESCRIPTION OF THE DRAWING

FIG. 1 is a schematic diagram of the method according to the invention.

FIG. 2 is a schematic diagram of how the method and kitset of the invention may be used in a process of tracing specimen DNA samples to their carcass source.

FIG. 3 is the sectional view 111-111 in FIG. 4.

FIG. 4 is a top plan view of a sampling strip according to the invention on roll stock being dispensed from a roll dispenser.

FIG. 5 is a top plan view of a carcass ticket.

FIG. 6 is a plan view of an open page of an embodiment of a document of description, in this example an animal passport.

### DETAILED DESCRIPTION OF THE INVENTION

Sampling and Storage

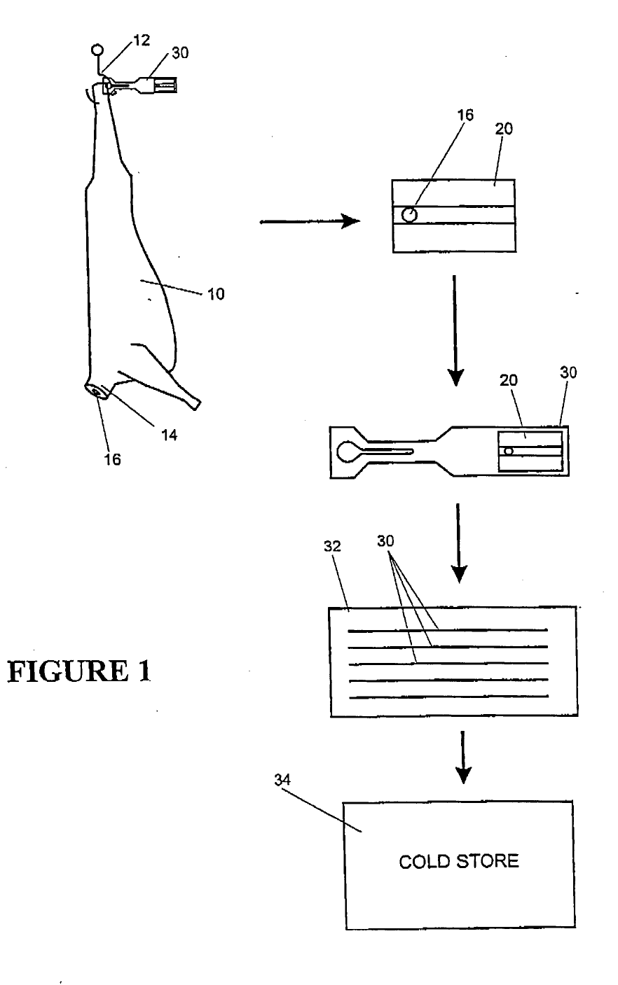

Illustrated in FIG. 1 is an animal carcass 10 slung from a carrying hook 12 along a killing chain in an abattoir. Attached to the hook 12 is a carcass ticket 30 which will be described in more detail below. The carcass ticket 30 may also be attached to the leg of the carcass in a manner well known to those skilled in the art.

On the neck 14 of the carcass 10 is the blood or lymph sample 16 to be collected. An operator standing next to the chain will remove a sampling strip 20 from the roll stock 28 being dispensed from a dispenser 27 (described below with reference to FIG. 4). The operator applies the sampling strip 20 face against the sample 16 so that the sample 16 is absorbed on the absorbent sheet 26 of the sampling strip 20. The operator then attaches the sampling strip 20 to the carcass ticket 30 and the carcass ticket 30 continues through processing where the carcass is cut into meat cuts packaged and distributed. The carcass tickets 30 with the samples attached are gathered in bunches and stored in ticket containers 32. For long term storage carcass tickets 10 with sampling strips 20 attached are allowed to dry and are then placed in water vapour permeable containers 32. These are stored in a dry environment either frozen (cold storage 34) or at room temperature.

At a point in the killing chain earlier than where the DNA sampling is done the carcass ticket 30 will have been labelled with identification indicia, such as bar coding, to identify the particular carcass 10.

A unique code could optionally be printed on the DNA-sampling strip 20 at the time of initial manufacture, or during delivery of the strip 20 via the dispenser 27.

DNA Tracing

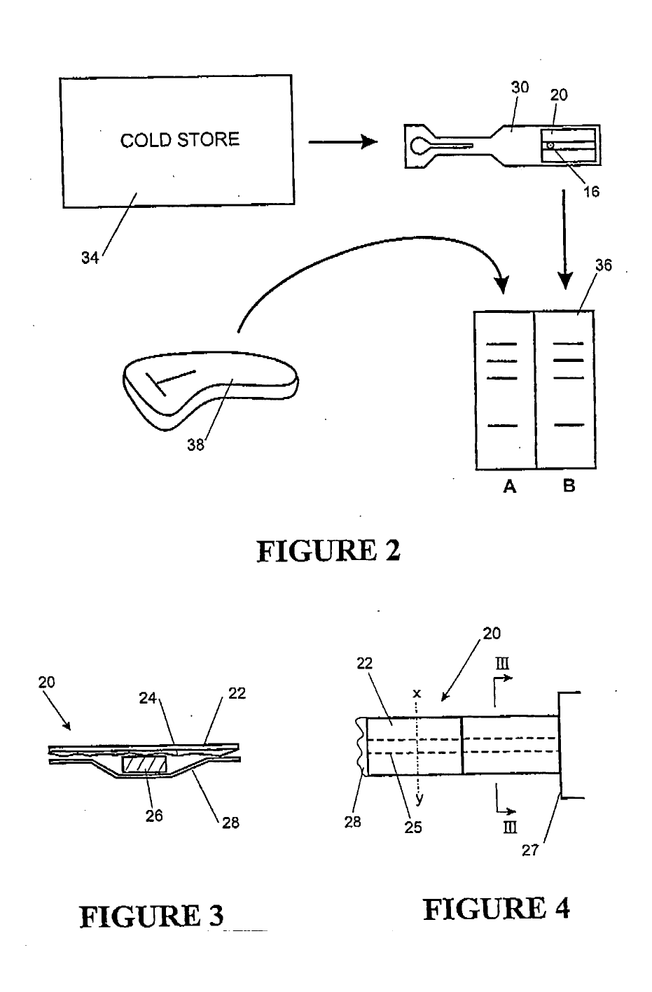

The purpose of storing DNA samples 16 with records of the individual sources of those samples on carcass tickets 30 is to allow tracing from meat cuts. Referring to FIG. 2, when a positive identification with the source needs to be made from a meat cut 38 a specimen is taken from the cut and subjected to genetic analysis. At the same time the carcass ticket storing the DNA sample from the suspected source of the meat specimen is also subjected to a DNA analysis on gels 36. The electrophoretic gels A and B illustrated here show that there is a match between the meat cut 38 and the carcass 10.

Sampling Strip

The structure of the sampling strip is illustrated in FIGS. 3 and 4. In a preferred embodiment the backing sheet 22 is a clear polystyrene film sold by Dow Chemical Company under the trade name “Opticite”. The thickness is 0.076 mm.

This product is compliant with the regulations of the US Food and Drug Administration (FPA) and thus may come into contact with meat carcasses intended for human consumption.

The adhesive 24 attached to backing strip 22 is “550” adhesive sold by Green Bay Packaging Inc of Green Bay, Wis., USA. It is intended for use in a cold environment. It may be applied at temperatures above minus 15 C. The minimum temperature for retaining adhesiveness is minus 49 C.

The absorbent sheet 26 on sample collecting strip 20 is preferably selected from two types of absorbent paper:
a) natural cellulose impregnated as described above in relation to U.S. Pat. No. 5,496,562. This is sold as “FTA” paper by Whatman PLC, and
b) uncoated cotton linter paper produced by Schleicher and Schuell Inc under the brand name “SNS 903”.

Both types of paper are suitable for direct contact with fatty and aqueous food. The latter product is a class 11 medical device listed by the FDA. The weight range is 185 to 210 gsm.

As illustrated in FIGS. 3 and 4, the sampling strip 20 is adhered to the release side of roll stock 28 which is despatched out of a dispenser 27. The dispenser is preferably one which retains the roll stock while a strip is being lifted and then releases a further length of roll stock with a sampling strip 20 attached.

The roll stock is a 70 gsm densified kraft sheet commonly used in the self adhesive industry. It has a soventless silicon release coating on the face to which the sampling strip 20 is attached so as to release the strip as required.

There are a series of perforations 25 through backing sheet 22. These are at either edge of absorbent sheet 26.

In a preferred embodiment absorbent sheet 26 has an orientation. One end is for handling and the other is where the sample 16 is collected as shown. The orientation can be indicated by making the backing sheet 22 transparent at the sample end and translucent or opaque at the handling end.

Another alternative manner of using a sampling strip 20 will be described with reference to FIG. 4. In this alternative the sampling strip 20 is folded along the line XY. The roll stock 28 is peeled from the right end to the line XY and the exposed portion applied to the carcass ticket 30. The remaining half is folded back with the piece of roll stock 28 remaining in place. When a carcass is to be sampled the roll stock 28 is removed and the sample taken by an operator holding the carcass ticket 30. The portion of the sampling strip 20 to the left of line XY, with a sample 16 taken, is then folded back to be attached to carcass ticket 30.

In a further alternative the portion of the sampling strip 20 to the right of line X-Y is integral with a substrate. In such an embodiment the absorbent sheet 26 and the adhesive layer 24 would not be present on the portion of the backing sheet 22 which is integral with substrate 28.

When a genetic analysis is to be made of a sample 16 from a sampling strip 20 as described with reference to FIG. 2 the usual procedure is to place the carcass ticket 30 with the sampling strip 20 attached to it in a punch and punch out the sample 16 on which the analysis is done. As an alternative to this it is possible to remove the absorbing sheet in its entirety by pulling it loose along the perforations 25.

Carcass Ticket

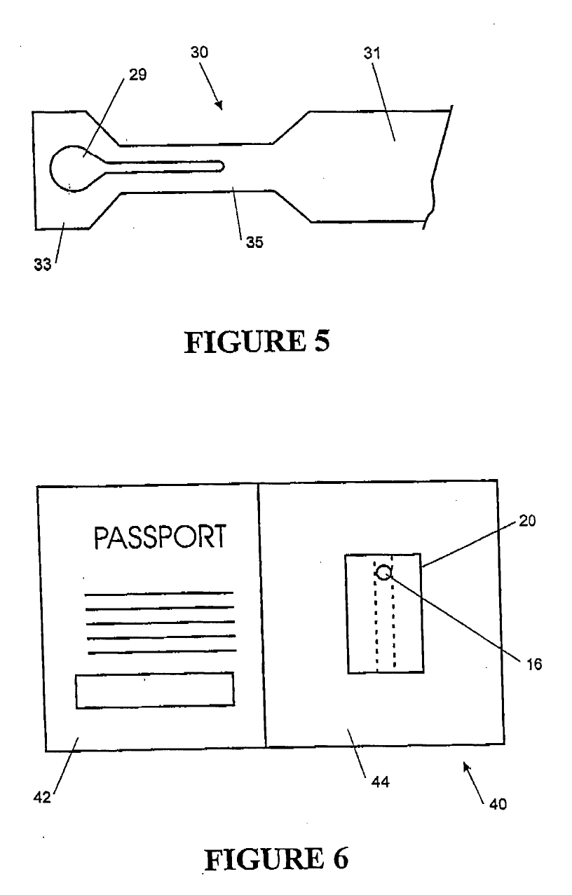

A carcass ticket 30 is illustrated in FIG. 5. It consists if a head portion 33, a neck portion 35 and a body portion 31. A hole 29 is cut through the head and neck portion to allow the tag to be hooked on to the hook from which the carcass is to be hung or onto the leg of the carcass itself. The body portion 31 serves to receive the sampling strip and also to be printed with the information identifying the source of the carcass 10.

In a preferred embodiment the carcass ticket 30 is a white polypropylene base sheet coated on one side with a thermal imaging coating with which to produce the identification information. The thermal coating is protected with an additional environmental protection coating to provide oil, water, heat, light and plasticiser resistance to the thermal coating. The imaging is black.

Documents of Description

Another use of the method of the invention is to provide positive identification on a document describing one or more animals. Such documents are referred to in this specification as “documents of description”. A document of description may be a single page, a folder or a book. It will contain a written number or letter identifier and a sample strip with a sample attached to a page of the document, the page being a substrate. Common examples of where a document of description is used include: animal registration or licensing systems, in animal health control programmes, bills of sale, entry form for a contest; during movement or import and export of animals or products from animals (animal passport). If there is any doubt as to the documentation then a DNA sample is taken from the animal and compared to the DNA sample in the document of description produced in relation to that animal.

Illustrated in FIG. 6 is a document of description in the form of an animal passport 40. The cover page 42 has the usual information. The sample page 44 serves as substrate function similar to that of the carcass ticket in the embodiment illustrated in FIGS. 1-5. The sampling strip 20 with the DNA sample 16 is stuck to the sample page 44 of the passport. It can be made of material similar to that of the carcass ticket 30.

At the time that the passport is being issued a blood sample may be taken on the sampling strip 20 which is then attached to the passport sample page 44 for the permanent record. The page may be laminated with a clear plastics material for additional security and for a longer storage life.

### EXAMPLE 1

Collection, Storage and Tracing of DNA Sample from Carcass Samples were collected by wiping a volume of blood from the neck of a carcass onto a DNA-sampling strip 20. The DNA-sampling strip was then attached by permanent adhesive 24 to the carcass identification ticket 30 hanging from the carcass 10. This procedure was used to sample all carcasses processed for a 10 metric tonne consignment of meat requiring traceability. The carcass identification tickets 30 with DNA sampling strips 20 attached were stored in cardboard boxes containing approximately 1000 tickets in numbered bunches of approximately 60 tickets. The tickets in each bunch were tied securely in the order of cutting. The boxes of DNA samples were entered onto an inventory system and stored at −20 C. DNA analysis of these stored tickets samples was used to trace meat from the market.

A trace was requested on 3 portions of meat from the market. Samples of the meat were taken by slicing open the meat and placing an FTA@ Card (Flinders Technologies PTY Ltd) into the cut, then closing the cut tightly until the FTA Card was saturated. The FTA Card was then air dried and mailed to a laboratory for analysis. Once received, a 1.2 mm diameter punch of each bloodstain was removed using a HARRIS MICRO-PUNCH (Shunderson Communications) and placed into a separate bar-coded or otherwise uniquely identified tube or receptacle. The identification of the receptacle and of the meat sample were entered into a spreadsheet or database. These data were used at a later date to relate the DNA profile to the sample identification. Both the FTA Card and Harris MICRO-PUNCH were obtained from the distributor Life Technologies, Inc., Gathersburg, Md., USA.

The date and time of production information on packaging of the meat was supplied to the ticket storage facility. The appropriate box of stored carcass tickets was identified and sent to the laboratory. A 1.2 mm diameter punch from the blood stain attached to each relevant ticket was removed using a HARRIS MICRO PUNCH (Shunderson Communications) and placed into a separate bar-coded (or otherwise uniquely identified) tube or receptacle. The identification of the receptacle and of the carcass ticket were entered into a spreadsheet or database and stored for later use in relating the DNA profile to the carcass information.

### EXAMPLE 2

### DNA Analysis

Punches from FTA® card and from the sampling strip 20 were each washed as follows. Using a Biomek 2000 Automated Workstation (Beckman Instruments, USA), 160 μl aliquots of FTA™ PURIFICATION REAGENT (Flinders Technologies PTY Ltd, supplied by Life Technologies Gibco-BRL) were dispensed into each well. Reagent was allowed to sit for 5 min at room temperature. After the 5 min incubation the reagent not soaked into the punch was removed. The above steps were repeated an additional two times for a total of three washes with the FTA™ Purification Reagent. After the FTA™ Purification Reagent has been removed for the third time, 160 l of TE (10 mM Tris-HCl, pH 8.0 m 0.1 mM EDTA) was dispersed into each well and mixed. The mixtures were allowed to sit for 5 min at room temperature. After the 5 min incubation most of the TE was aspirated. An additional 160 μl of TE buffer was added. After the final TE buffer had been removed, 160 μl 96% ethanol was added, incubated for 5 min and aspirated.

The FTA paper punch was allowed to air dry completely (approximately 2 hours at room temperature). Alternatively, drying was accelerated by incubating the plate of punches at 60 C for 30 min.

The washed punches were analysed by the polymerase chain reaction. The resulting samples from the meat specimen punch and the carcass sample punch were loaded onto separate lanes of ABI 377 gel (36 cm plate); Run module GS 36C/2400 (Applied Biosystems Inc.).

The output of ABI377 was analysed using Genescan and Genotyper Software (Applied Biosystems Inc.). The results from each carcass ticket sample were compared with the profile from the meat sample. Profiles identical within the tolerance of the analysis system (plus or minus lbp) are selected as “matches”. The likelihood that this match could have occurred by chance was calculated using standard methods and allele frequency data derived from the other animals analysed at the time. A single matching carcass ticket sample was identified for each meat sample. In each case the likelihood that such a DNA match could occur with a carcass ticket from a different animal was less than one chance in one million tests.

The DNA link between the sample of meat from the market place and the stored carcass sample was used relate information previously only associated the carcass to the submitter of the sample of the meat cut. The data included farm of origin, farm and transport quality assurance data, weight and grade of carcass.

Other Applications

Although the method of the invention has been described in relation to DNA sampling, other potential analyses which could be done on the samples taken using the DNA sampling strip include:
1) Qualitative or quantitative analysis of microbes or products produced by microbes,
2) Genotyping or DNA sequencing from DNA or RNA for example for the purposes of animal identification, parentage testing, species or strain identification, or testing for the presence or absence of a specific gene or mutation, and
3) Quantitative or qualitative analysis of proteins.

The method and kitset of the invention can be used in any application requiring rapid sampling of fluid from plant or animal tissue for diagnostic or reference purposes and clear identification of the sample is paramount.

Possible applications including taking samples from live animals including humans, dead animals/humans or tissue. Samples would include blood, saliva, mucus, plasma, body fluid such as milk and crushed or homogenised tissue such as muscle. The sampling strip with the sample is stuck to pre-existing, or custom printed document of description concerning the animal or human (including a book, passport, photograph, card, tag, ticket-any format for printed material).

For example, when animals are being tagged or handled a sample of blood is collected using a lancet to prick the ear and soaking one or two drops of blood onto the DNA sampling strip 20 label. The sampling strip is then permanently stuck to a substrate 30 in the form of a card, book or passport, or photograph which lists all details concerning the animal tag (eg: colour, number, radio or other electromagnetic frequency emission). This information could be pre-existing or could be printed just prior to or during the sample being taken.

The method and kitset of this invention could also be used in the same way to trace the plant origin of materials. The plant products to be traced could be sap, fruit juice, or crushed or homogenised plant tissue.

Other variations and permutations within the scope of the claims will be apparent to those skilled in the art.

What is claimed is:

1. A method for collecting and storing a biological sample for later identification of the sources of said sample which comprises the steps of:
providing a sampling strip, one face of which has an absorbent area impregnated with a DNA stabilising composition and defining a sampling area and an adhesive area: the other face of which covers and protects the sampling area,
collecting a biological sample on said absorbent area,
providing an identification substrate having a surface area to receive said sampling strip,
applying said sampling strip containing said biological sample to said substrate so that said absorbent area is enveloped between the outer face of said strip and said substrate,
marking said substrate and/or said sampling strip either before, during or after said applying stage with indicia to identify the source of the biological sample collected on said sample collecting strip, and
storing said combined marked substrate/strip.

2. A method as claimed in claim 1 or claim 30 wherein said biological sample is a source of DNA.

3. A method as claimed in claim 2 wherein said source of DNA is blood, lymph or saliva.

4. A method as claimed in claim 1, wherein said biological sample is taken from an animal carcass.

5. A method as claimed in claim 1, wherein said identification substrate is a carcass ticket.

6. A method as claimed in claim 1, wherein said biological sample is taken from a live animal.

7. A method as claimed in claim 1, wherein said substrate is a document of description.

8. A method as claimed in claim 1, wherein said method is used within a system to trace the origin of meat or other foodstuffs.

9. A method as claimed in claim 1, wherein said marked combined substrate/strip is stored in dry storage.

10. A method as claimed in claim 1, wherein said marking is done on said identification substrate before said sampling strip is affixed thereto.

11. A biological specimen sample storage and identification kitset comprising:
a sampling strip consisting essentially of:
a backing sheet, one side of which covers and protects a sampling area,
a layer of adhesive covering and adhered to the other face of said backing sheet,
a biological sample absorbent area impregnated with a DNA stabilising composition adhered to said adhesive layer on said backing sheet, the area covered by said absorbent area being limited to leave a sufficient area of exposed adhesive to allow said backing sheet to be stuck to a substrate with said absorbent area therebetween, and
a substrate to which said sampling strip may be affixed by said adhesive, said substrate being capable of receiving printed indicia to identify the source of said sample.

12. A kitset as claimed in claim 11 wherein said biological sample is a source of DNA.

13. A kitset as claimed in claim 12 wherein said sample is blood, lymph or saliva.

14. A kitset as claimed in claim 11, wherein said adhesive is selected for high adhesivity and to maintain adhesion at cold storage temperatures.

15. A kitset as claimed in claim 11, wherein said adhesive is a food grade adhesive.

16. A kitset as claimed in claim 11, wherein said sampling strip is adapted to be supplied with said adhesive and sampling sheet face down on a sheet of roll stock and wherein said adhesive and sheet surface has low adhesivity to allow quick removal of said sampling strip.

17. A kitset as claimed in claim 11, wherein the backing sheet has perforations through said backing sheet, the perforations only being disposed along the outer periphery of said sampling area.

18. A kitset as claimed in claim 11, wherein said substrate is a carcass ticket.

19. A kitset as claimed in claim 11, wherein said substrate is a page of a document of description.

20. A kitset as claimed in claim 11, wherein a first portion of said sampling strip is adhered to or is integral with said substrate and a second portion faces away from said substrate, a release sheet being releasably adhered to said second portion of said sampling strip, said substrate being adapted to receive said second portion and to be adhered thereto when said release sheet has been removed and said second portion is applied thereto.

21. A method according to claim 11; which comprises:
using a kitset comprising a sampling strip consisting essentially of:
a backing sheet, one side of which covers and protects a sampling area,
a layer of adhesive covering and adhered to the other face of said backing sheet,
a biological sample absorbent area impregnated with a DNA stabilising composition adhered to said adhesive layer on said backing sheet, the area covered by said absorbent area being limited to leave a sufficient area of exposed adhesive to allow said backing sheet to be stuck to a substrate with said absorbent area therebetween, and
a substrate to which said sampling strip may be affixed by said adhesive, said substrate being capable of receiving printed indicia to identify the source of said sample, said substrate being a page of a document of description,
removing said release sheet,
applying said sample absorbing sheet to said source of DNA, and
sticking said second portion of said sampling strip to said substrate.

22. A sampling strip which has one face including
an adhesive area, and
an adhesive area,
the sampling strip characterised in that the absorbent area includes DNA sampling paper impregnated with a DNA stabilising composition.

23. A sampling strip for use with the method as claimed in claim 1.

24. A sampling strip for use in a kitset as claimed in claim 11.

25. A method as claimed in claim 1 wherein the sampling strip has perforations through said sampling strip, the perforations only being situated along the outer periphery of said sampling area.

26. A sampling strip as claimed in claim 23, wherein the sampling strip has perforations through said sampling strip, the perforations only being situated along the outer periphery of said sampling area.
